(19) United States
(12) Patent Application Publication
(10) Pub. No.: US 2014/0193029 A1
(43) Pub. Date: Jul. 10, 2014

(54) Text Detection in Images of Graphical User Interfaces

(71) Applicant: Natalia Vassilieva, St. Petersburg (RU)

(72) Inventor: Natalia Vassilieva, St. Petersburg (RU)

(21) Appl. No.: 13/736,258

(22) Filed: Jan. 8, 2013

(51) Int. Cl. G06K 9/46

(52) U.S. Cl. CPC G06K 9/46
USPC 382/103

(57) ABSTRACT

Systems and methods for text detection are provided. An image is received, and a set of connected components in the image are determined. For each connected component in the set, a bounding area is determined. A set of regions of the image are determined, based on the bounding area. Each region in the set of regions is classified and normalized based on the classification. The normalized set of regions is merged into a binary image.

### I. BACKGROUND

Text detection in images has many applications, such as image indexing for multimedia content retrieval and automatic navigation assistance for the visually impaired, robotic navigation in urban environments and many others. Generally, approaches to text detection involve two classes of images: document images and natural scene images. The distinction between the classes is made based upon the properties of the image under analysis. As used herein, text detection refers to the process of determining the presence of text in a given image. Text is an alignment of characters, which includes letters or symbols from a set of signs.

Document images are images of documents (e.g., handwritten, typewritten, printed text). Document images are typically assumed to include characters in a dark color (e.g., black) with a high contrast against a background that is homogenous in color. Additionally, document images have the property of having large text segments and simple and structured page layouts. One way of processing document images is via optical character recognition (OCR). The OCR process is a computer-based translation of an image of text into digital form as machine-editable text, generally in a standard encoding scheme.

In contrast to document images, scene images have far less text, with complex backgrounds and text that varies in font size, font color, and text line orientation

### II. BRIEF DESCRIPTION OF THE DRAWINGS

The present disclosure may be better understood and its numerous features and advantages made apparent by referencing the accompanying drawings.

FIG. 1 is a process flow diagram for image processing in accordance with an embodiment.

FIG. 2 is a process flow diagram for determining a set of regions of an image in accordance with an embodiment.

FIG. 3 is a process flow diagram for binarization and classification of regions of an image in accordance with an embodiment.

FIG. 4 is an image of a graphical user interface in accordance with an embodiment.

FIG. 5 is an image of a graphical user interface after edge detection in accordance with an embodiment.

FIG. 6 is an image of a graphical user interface after edge detection and global binarization of an edge map in accordance with an embodiment.

FIG. 7 is a binary edge map of an image of a graphical user interface after the removal of long lines in accordance with an embodiment.

FIG. 8 is a binary edge map of an image of a graphical user interface after connected-component labeling in accordance with an embodiment.

FIG. 9 is a binary edge map of an image of a partial graphical user interface showing bounding rectangles in accordance with an embodiment.

FIG. 10 is a binary edge map of an image of a graphical user interface showing bounding rectangles filtered by size in accordance with an embodiment.

FIG. 11 is a binary edge map of an image of a graphical user interface showing bounding rectangles filtered by size and inclusion of other rectangles in accordance with an embodiment.

FIG. 12 is an image of a graphical user interface after binarization in accordance with an embodiment.

FIG. 13 is a resulting image of a graphical user interface after text detection in accordance with an embodiment.

FIG. 14 illustrates a computer system in which an embodiment may be implemented.

### III. DETAILED DESCRIPTION

Graphical user interfaces (GUIs), as captured in screen images, have different properties than images of documents and natural scenes. In particular, this type of screen image (i.e., GUI as captured in a screen image) generally has text entries that include a few words and characters, and vary in font size and color, as opposed to document images. As such, GUI screen images are difficult to process by typical document processing methodologies. Furthermore, GUI screen images may have sharp edges and/or color transitions, and has text that is easier to detect, as opposed to natural scene images. As such, computationally complex natural scene processing methodologies are inefficient for the processing of GUI screen images.

The processing of a third class of image, i.e., GUI screen images, is described herein. In particular, the processing of graphical user interfaces (GUIs) as captured in screen images involves the structural analysis of those images without knowledge of the internal representation of the GUI objects. As a result of such processing, which is agnostic to the technology which was used to build the GUI itself, text may be detected and extracted from the images.

Text detection in GUI screen images may enable the detection of GUI controls and the types of these controls. Furthermore, the accuracy and performance of optical character recognition (OCR) of text content in GUI screen images can be greatly improved.

Systems and methods for text detection are provided. An image is received, and a set of connected components in the edge map of the image are determined. For each connected component in the set, a bounding area is determined. A set of regions of the image are determined, based on the bounding area. Each region in the set of regions is classified (e.g., as one of a white-text region, a black-text region, and non-text region) and normalized based on the classification. The normalized set of regions is merged into a binary image.

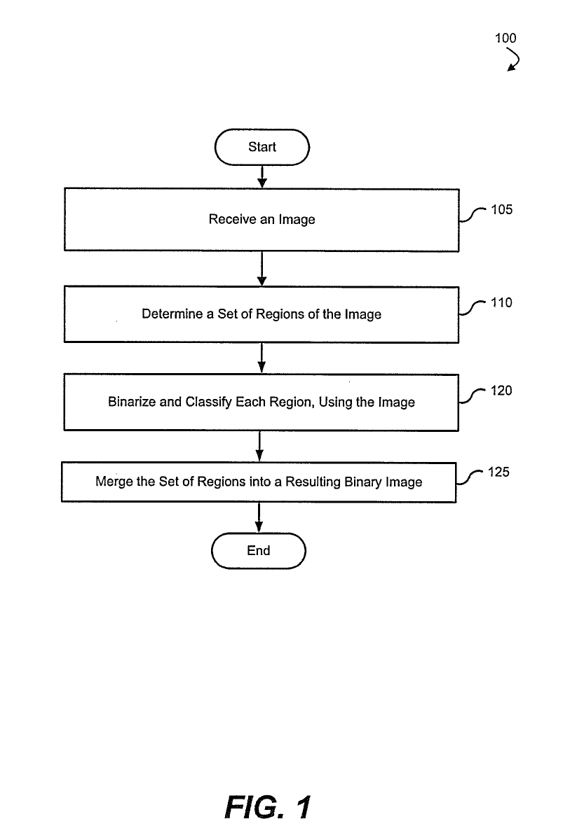

FIG. 1 is a process flow diagram for image processing in accordance with an embodiment. The depicted process flow 100 may be carried out by execution of sequences of executable instructions. In another embodiment, various portions of the process flow 100 are carried out by components of a character detection engine, an arrangement of hardware logic, e.g., an Application-Specific Integrated Circuit (ASIC), etc. For example, blocks of process flow 100 may be performed by execution of sequences of executable instructions in a text detection module.

At step 105, an image is received as an input. In one embodiment, the image is a screen image of a graphical user interface (GUI), although other images with similar properties may be received and processed as described herein.

As used herein, the input image is an electronic snapshot (e.g., screenshot) taken of a GUI or other subject with similar properties, as previously described. The input image is sampled and mapped as a grid of dots or pixels. Each pixel is assigned a tonal value (black, white, shades of gray or color), which is represented in binary code (zeros and ones). The binary bits for each pixel are stored in a sequence and can be reduced to a mathematical representation, for example when compressed.

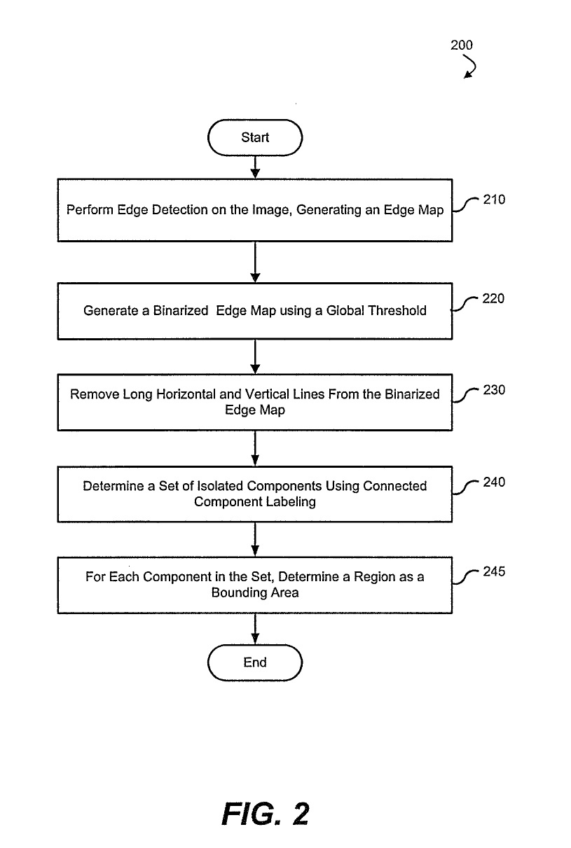

A set of regions of the image is determined, at step 110. In one embodiment, connected-component labeling is performed where connected components in the input image are uniquely labeled. Various methodologies for connected component labeling or blob detection (e.g., two-pass, etc.) may be used. A bounding area is determined for each of the connected components. Each bounding area corresponds to a region within the image. The coordinates of bounding areas are used on top of the initial input image to determine the region of the original input image that is covered by the bounding area. Further details for determining the set of regions is described with respect to FIG. 2.

Using the input image, adaptive threshold binarization and classification is performed on each of the regions in the set, at step 120. Usually, the text in a GUI is designed to be easily read by the user, and as such, there is a sharp contrast between characters and background in the GUI and in the corresponding GUI screen image. Furthermore, there is typically no noise or insufficient lighting in this type of image. Adaptive threshold binarization provides a fast and efficient way for separating text from the background, when applied locally to particular regions.

As described herein, binarization is the process of generating a binary image by converting a pixel in an image into one of two possible values, i.e., 1 or 0. All pixels are converted to either black or white. The result will be either white text on a black background or black text on a white background, depending on the color of the background and foreground at each region in the input image.

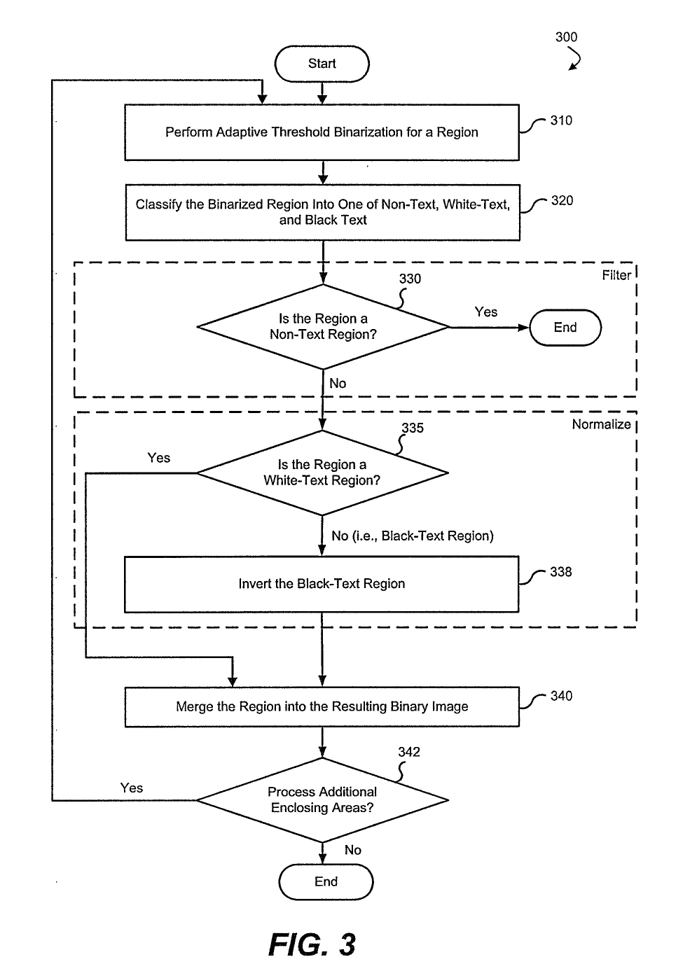

A classifier, such as a Naïve Bayes classifier, is used to identify non-text regions, and during processing of the image, filter out those regions that have been identified as non-text regions. Furthermore, the classifier may be used to normalize the regions, such that the text across all regions in the set is uniform in color representation. For example, the image as processed thus far may include a webpage title with dark text on a white background, whereas the body may depict the content in white text against a dark background. The classifier unifies the text and background of each region to be either white text against a dark background or dark text against a white background. Further details of the adaptive binarization and classification process are provided with respect to FIG. 3. In one embodiment, the classifier allows filtering out non-text regions and normalizing the text and background in a single pass.

At step 125, the set of regions are merged into a resulting binary image, which has separated text and background, and is clear (or mostly clear) of non-text regions. The merge is accomplished using the coordinates of the bounding areas. At this point, any standard character recognition scheme may be used to convert the image of text into machine-encoded text.

FIG. 2 is a process flow diagram for determining a set of regions of an image in accordance with an embodiment. The depicted process flow 200 may be carried out by execution of sequences of executable instructions. In another embodiment, various portions of the process flow 200 are carried out by components of a character detection engine, an arrangement of hardware logic, e.g., an Application-Specific Integrated Circuit (ASIC), etc. For example, blocks of process flow 200 may be performed by execution of sequences of executable instructions in a text detection module.

In one embodiment, process flow 200 provides further details of step 110 of FIG. 1. At step 210, edge detection is performed on the input image. An edge is a significant local change of intensity in an image. Edges typically occur on the boundary (e.g., object boundary, surface boundary, etc.) between two different areas in images, for example between a character and a background. The goal of edge detection is to produce a line drawing from the image. Various methodologies of edge detection may be employed. For example, gradient or Laplacian methodologies may be used. The output of edge detection is an edge map of the input image.

At step 220, a binary edge map is generated, for example using a global threshold for the entire edge image (e.g., edge map). The global threshold is used to separate image pixels and background image pixels of objects. The edge map of the image may include pixels that are black, white, and/or shades of gray. Binarization at this stage modifies the pixels with shades of gray to binary form (e.g., all black or white pixels).

Long horizontal and vertical lines are removed from the binary edge map, at step 230. These lines are typically indicative of the boundaries among different sections of the input image (e.g., sections of a GUI screen image) and are unlikely to be text. As such, the long horizontal and vertical lines may be discarded. Various methods of identifying the lines may be used. In one embodiment, step 230 may be skipped if it is not relevant for the type of image.

At step 240, a set of isolated components of the binary edge map (with long lines removed) are determined using connected-component labeling. At a high level, a group of pixels are identified as a region where there is sufficient connectedness among the pixels. For example, a current pixel in the input image may be checked against various conditions, such as whether another pixel of the same intensity (or tonal value, e.g., also black or also white) is an 8-connection neighbor, i.e., neighbor to the north, south, east, west, and diagonals.

If these conditions are met, the neighboring pixel and the current pixel are deemed to be a part of the same component. Each of the identified components makes up a distinct blob. The components may be used to identify a letter(s), a number(s), a word(s), other text elements, and non-text elements in the image. The component may include a word, for example when the font size is small and character edges are merged with neighboring characters. The component may include a character, for example when the font size is large. The component may include non-text blobs of high contrast.

At step 245, for each component in the set, a region as a bounding area (e.g., bounding rectangle) is determined. The bounding rectangles are the coordinates of a rectangular border that fully encloses the component. Various other bounding shapes may be employed. The coordinates of bounding areas are used on top of the initial input image to determine the region of the original input image that is covered by the bounding area.

Various methodologies may be used to identify the proper regions for binarization. For example, computationally expensive segmentation methodologies may be used. In another embodiment, regions of fixed size (e.g., half of the image or a third of the image) may be selected.

In one embodiment, filtration of the bounding areas is performed in order to optimize performance, for example by reducing the number of bounding rectangles that are later binarized and classified. As used in this context, filtration involves selectively removing certain bounding rectangles from the set of bounding rectangles for the image.

In one example, filtration is based on the size of the bounding rectangle. If the bounding rectangle is too small or thin (e.g., one pixel in width), it is deemed to have failed a minimum size limitation and is discarded. Likewise, a maximum size limitation may be imposed, such that if the bounding rectangle is too large (e.g., half of the entire image), it is deemed to have failed the maximum size limitation and is discarded.

In another example, overlapping bounding rectangles are candidates for filtration. As used herein, overlapping bounding rectangles are those which have an area of the image in common. A nested bounding rectangle is one example. To select which overlapping bounding rectangles to remove, the bounding rectangles may be sorted by their square, from highest to lowest. Then, for every bounding rectangle, the count of how many smaller inner or overlapping rectangles share the same area of the image is determined. Based upon this count, it is decided whether to discard the outer (or otherwise larger) bounding rectangle or discard the inner (or otherwise smaller) bounding rectangles. When there are not too many inner bounding rectangles, the outer rectangle is kept and the inner rectangles are discarded. On the other hand, when the number of inner bounding rectangles are too numerous, the outer rectangle is discarded, leaving the smaller, inner rectangles within the set of bounding rectangles. The assumption is that many inner bounding rectangles may be indicative of many different coloring schemes in that part of the image, which may function to properly distinguish characters from the background.

FIG. 3 is a process flow diagram for binarization and classification of regions of an image in accordance with an embodiment. The depicted process flow 300 may be carried out by execution of sequences of executable instructions. In another embodiment, various portions of the process flow 300 are carried out by components of a character detection engine, an arrangement of hardware logic, e.g., an Application-Specific Integrated Circuit (ASIC), etc. For example, blocks of process flow 300 may be performed by execution of sequences of executable instructions in a text detection module.

In one embodiment, process flow 300 provides further details of step 120 of FIG. 1. At step 310, adaptive threshold binarization is performed for a region using the input image, rather than being applied on the entire image. The adaptive thresholding is based on the particular image statistics for each distinct region of the image corresponding to the bounding area. For example, during the thresholding process, individual pixels in a region of the image are marked as “object” pixels if their value is greater than some threshold value (assuming an object is brighter than the background) and as “background” pixels otherwise. The binarization is adaptive in that the threshold can vary from bounding area to bounding area, depending on the image statistics for the particular bounding area. There are many approaches to determining the threshold, e.g., mean (0.5 (max+min)), iterative, etc. In one embodiment, the threshold is determined by:

$${e}_{x} = I ( x + 1 , y ) - I ( x - 1 , y )$$

$${e}_{x} = I ( x + 1 , y ) - I ( x - 1 , y )$$

$$weight = max ( {e}_{x} , {e}_{y} )$$

$${weight}_{total} += weight$$

$$total += weight * I ( x , y )$$

$$threshold = \frac{total}{{weight}_{total}}$$

The result will be either white text on a black background, or black text on a white background, depending on the color of the background and foreground at each region as a bounding area in the input image.

As previously described, a classifier is used to identify non-text regions, and during processing of the image, filter out those regions that have been identified as non-text regions. At step 320, the binarized region corresponding to a bounding area is classified. In one embodiment, a Naïve Bayes classifier is used to identify the region as one of three groups: non-text, white-text, and black text areas. Features of each region corresponding to the bounding area may be used to perform the classification.

For white pixels, the variance of stroke width is examined. More specifically, for a white pixel in the bounding area, the neighbors are examined to identify the minimal distance to the next black pixel. The assumption is that the stroke width for a character(s) within the bounding area should be more or less uniform, i.e., small variance. As such, if the variance is big, the bounding area may not be properly classified as white text.

Likewise, for black pixels, the variance of stroke width is examined. More specifically, for a black pixel in the region, the neighbors are examined to identify the minimal distance to the next white pixel. The assumption is that the stroke width for a character(s) within the bounding area should be more or less uniform, i.e., small variance. As such, if the variance is big, the region may not be properly classified as black text.

The ratio of white pixels to black pixels in the region is examined. The assumption here is that when there is text, typically, there is around 30-40% background and the remaining pixels are foreground. The further away the ratio is from this, it is most likely that the region does not include text, and instead, is more likely to be non-text.

The ratio of white pixels to black pixels along the border of a region are examined. Based on the way the regions are selected, the bounding rectangle is usually around the character(s). The border of a region is more likely to include pixels in the background, rather than the foreground. The assumption is that the majority of pixels along the border of the region are background. If that is not the case, it is unlikely that the region is a text region, and instead, is more likely to be non-text. The border is a bounding rectangle, without the inner area.

The aforementioned features are used to classify the region corresponding to a bounding area. Other classifiers may be used, such as decision trees (e.g., such as C4.5) and support vector machines (SVM).

Once the bounding area has been classified, the classification may be used to filter out non-textual regions in the image and/or to normalize the regions, such that the text across all regions in the set are uniform in color representation. At step 330, it is determined whether the region is classified as a non-text region. If so, the region is filtered out or otherwise not included in the set of regions that are later merged to form the resulting binary image, at step 340.

The classification may also be used to normalize the text and background of each region (e.g., bounding area) to be either white text against a dark background or dark text against a white background. In one embodiment, the regions are normalized to show white text on a dark background. For example, at step 335, it is determined whether the region is a white-text region. Where it is, that region is merged into the resulting binary image, at step 340. The image can be thought of as being broken up into composite parts (i.e., regions), and each of the parts are analyzed separately. The merge process takes the composite parts (the regions that have not been discarded from the set of regions) and puts them together, using the coordinates of each region (e.g., boundary area coordinates).

Where the bounding area is not a white-text region, it is determined that it is a black text region and is inverted, at step 338. The invert operation produces a white text region with a dark background, which is then merged into the resulting binary image, at step 340. Although normalization to white text is shown in FIG. 3, normalization to black text may also be implemented. In one embodiment, the portions of the image which do not have any bounding areas are assumed not to have any text and are depicted as the background color in the final image.

As indicated by loop 310-342, each region in the set may be iterated, applying the adaptive threshold binarization, classification, filtering, and normalization processes. As previously described, classifier allows filtering out non-text regions and normalizing the text and background in a single pass.

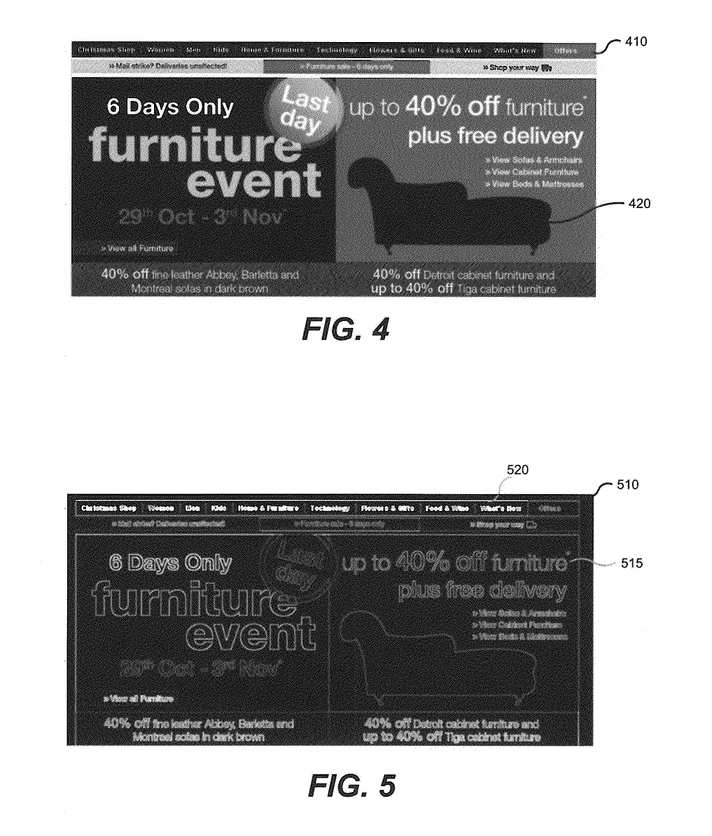

FIG. 4 is an image of a graphical user interface in accordance with an embodiment. In particular, image 410 is an input image of a GUI of a shopping website. The color in image 410 is shown in grayscale, however, the image may be processed in its true color-value form.

FIG. 5 is an image of a graphical user interface after edge detection in accordance with an embodiment. Image 510 is a result of performing edge detection on image 410 of FIG. 4. Image 510 is an edge map. The pixels in the edge map are assigned a tonal value of white and shades of gray. The text 515 is presented in a shade of gray, whereas the text 520 is presented in white.

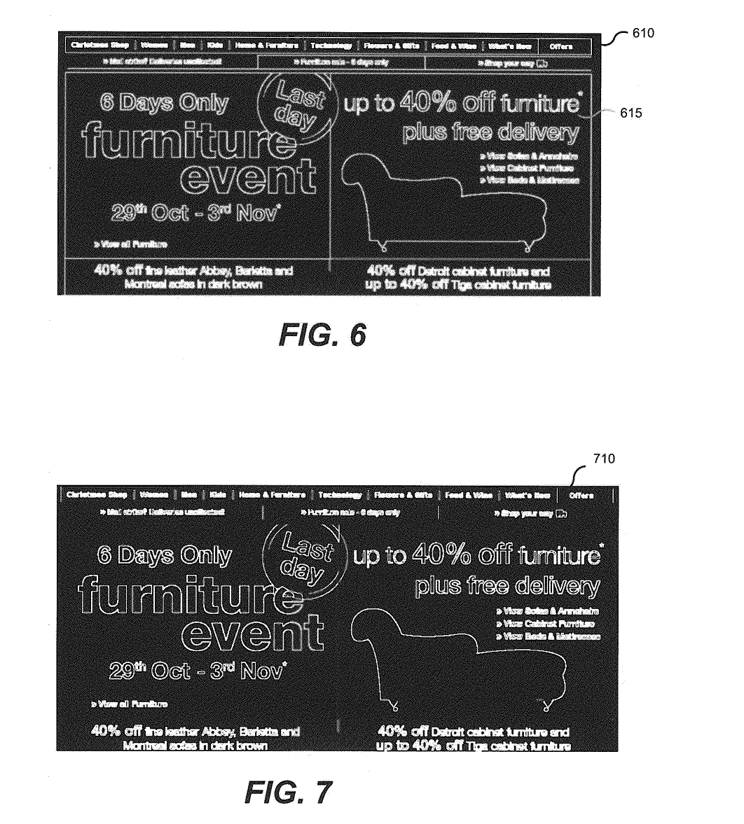

FIG. 6 is an image of a graphical user interface after edge detection and global binarization of an edge map in accordance with an embodiment. Image 610 is the result of performing global threshold binarization on image 510 of FIG. 5. Image 610 is a binary edge map. The text 615 was previously presented in a shade of gray, but was modified to binary form, i.e., white. It should be recognized that each pixel in the a binary edge map is in binary form.

FIG. 7 is a binary edge map of an image of a graphical user interface after the removal of long lines in accordance with an embodiment. Image 710 is the result of removing long horizontal and vertical lines on image 610 of FIG. 6.

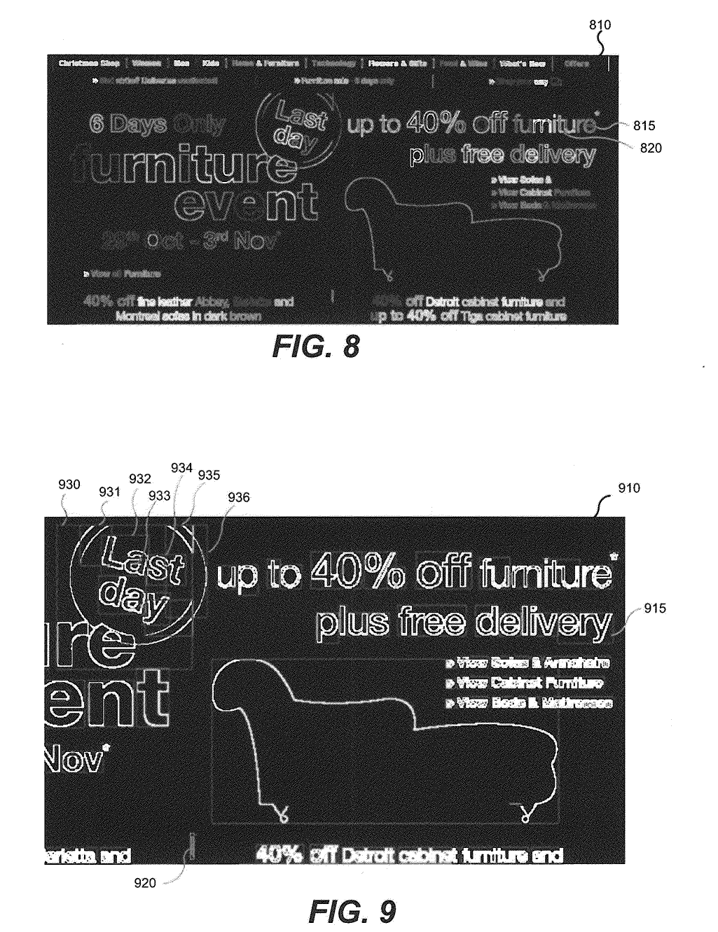

FIG. 8 is a binary edge map of an image of a graphical user interface after connected-component labeling in accordance with an embodiment. Image 810 is the result of connected-component labeling on image 710 of FIG. 7. For purposes of illustration, each connected component in the image is represented in grayscale, i.e., of varying intensity. As shown, a connected component 815 is comprised of the letters “re” in the word “furniture.” Another connected component 820 (shown in a lighter gray intensity) is comprised of the letters “itu” in the same word. In total, the word “furniture” is made up of four distinct components.

FIG. 9 is a binary edge map of an image of a partial graphical user interface showing bounding rectangles in accordance with an embodiment. Image 910 is a zoomed portion of the result of generating bounding rectangles on image 810 of FIG. 8. As shown, bounding rectangle 915 encloses the letters “ery” in the word “delivery” of image 910, since the letters “ery” are connected components and the letter “v” is not connected to the letter “e.”

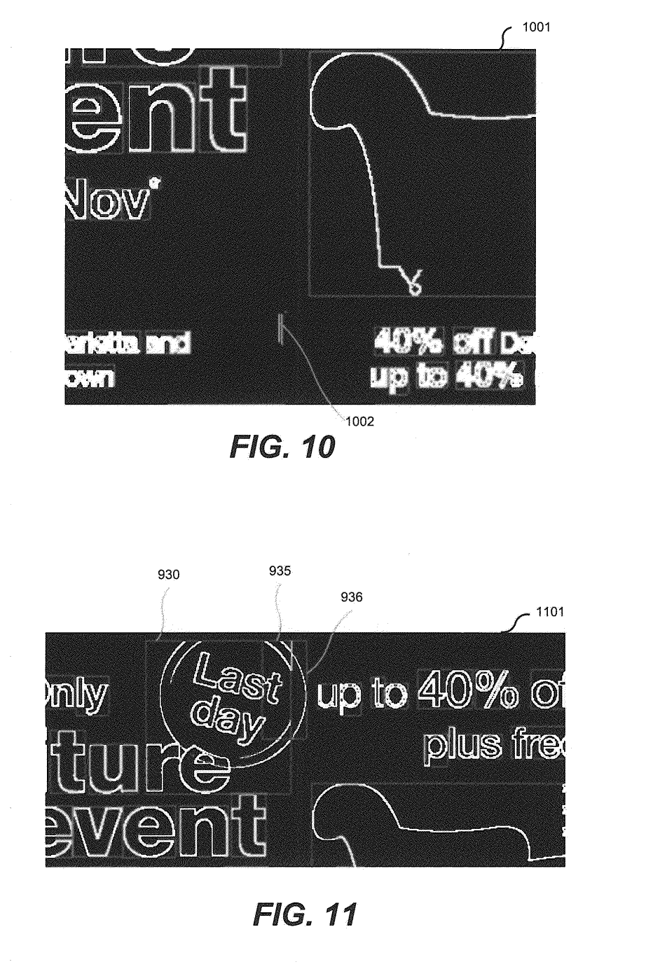

FIG. 10 is a binary edge map of an image of a partial graphical user interface showing bounding rectangles filtered by size in accordance with an embodiment. Image 1001 is a zoomed portion of the result of filtering bounding rectangles on image 910 of FIG. 9 based on size. Referring to FIG. 9, the short line segment 920 is shown as including a thin bounding rectangle 920. In contrast, referring back to FIG. 10, the bounding rectangle does not appear around the short line segment 1002. As previously described, bounding rectangles that do not satisfy a minimum size limitation are discarded.

FIG. 11 is a binary edge map of an image of a graphical user interface showing bounding rectangles filtered by size and inclusion of other rectangles in accordance with an embodiment. Image 1101 is a zoomed portion of the result of filtering bounding rectangles on image 910 of FIG. 9 based on size and inclusion of other rectangles. Referring to FIG. 9, multiple overlapping bounding rectangles 930-936 are shown. In particular, bounding rectangles 931-934, among others, are nested with respect to bounding rectangle 930. In contrast, referring back to FIG. 11, many of the overlapping bounding rectangles have been discarded, leaving the bounding rectangles 930, 935, and 936.

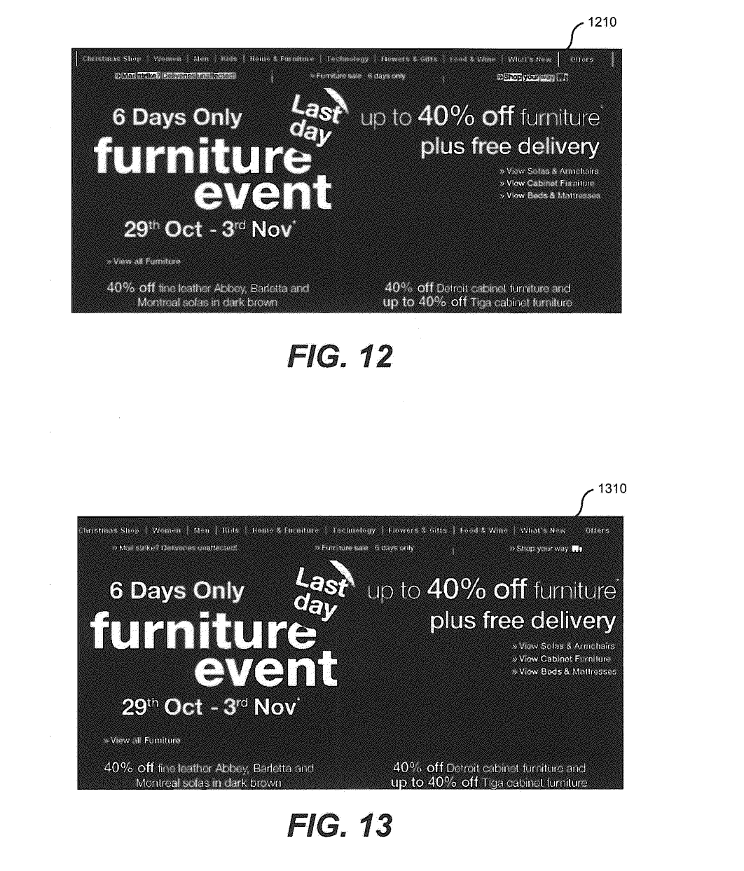

FIG. 12 is an image of a graphical user interface after binarization in accordance with an embodiment. Image 1210 is the result of adaptive threshold binarization and filtering out non-text regions on image 410 of FIG. 4. It should be recognized that the sofa 420 from FIG. 4 no longer appears in image 1210. Since the sofa is classified as a non-text region, it is removed from the resulting image. In another embodiment, the sofa 420 is filtered out based on a maximum size limitation of the bounding rectangle.

FIG. 13 is a resulting image of a graphical user interface after text detection in accordance with an embodiment. Image 1310 is the result of normalizing the text and background on image 1210 (to white text, dark background) of FIG. 12, and merging the regions in the set.

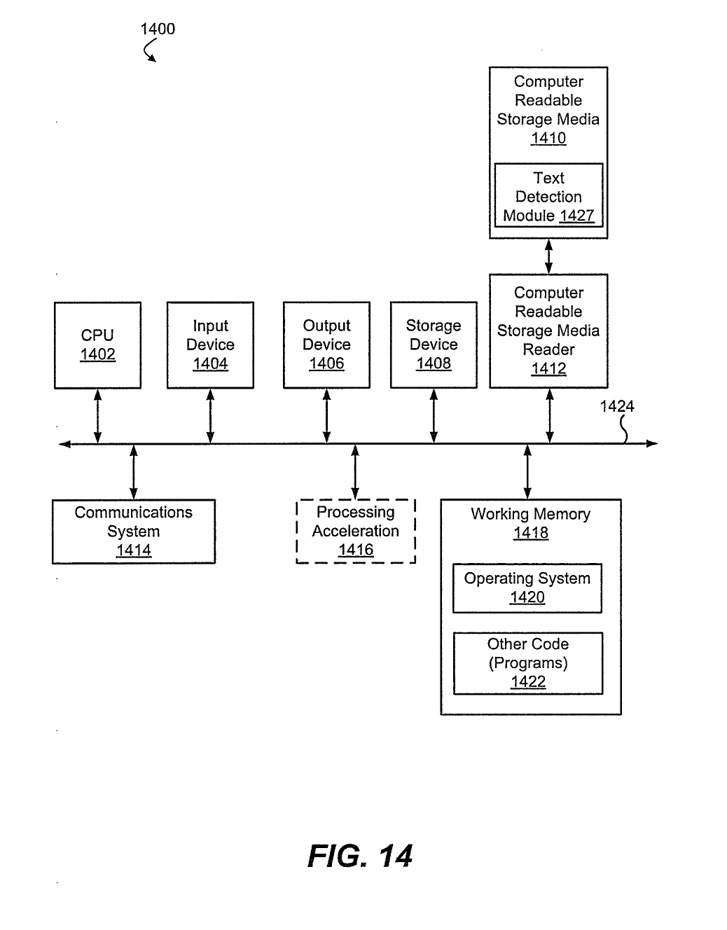

FIG. 14 illustrates a computer system in which an embodiment may be implemented. The system 1400 may be used to implement any of the computer systems described above. The computer system 1400 is shown comprising hardware elements that may be electrically coupled via a bus 1424. The hardware elements may include at least one central processing unit (CPU) 1402, at least one input device 1404, and at least one output device 1406. The computer system 1400 may also include at least one storage device 1408. By way of example, the storage device 1408 can include devices such as disk drives, optical storage devices, solid-state storage device such as a random access memory (“RAM”) and/or a read-only memory (“ROM”), which can be programmable, flash-updateable and/or the like.

The computer system 1400 may additionally include a computer-readable storage media reader 1412, a communications system 1414 (e.g., a modem, a network card (wireless or wired), an infra-red communication device, etc.), and working memory 1418, which may include RAM and ROM devices as described above. In some embodiments, the computer system 1400 may also include a processing acceleration unit 1416, which can include a digital signal processor (DSP), a special-purpose processor, and/or the like.

The computer-readable storage media reader 1412 can further be connected to a computer-readable storage medium 1410, together (and in combination with storage device 1408 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 1410 may be non-transitory such as hardware storage devices (e.g., RAM, ROM, EPROM (erasable programmable ROM), EEPROM (electrically erasable programmable ROM), hard drives, and flash memory). The communications system 1414 may permit data to be exchanged with the network and/or any other computer described above with respect to the system 1400. Computer-readable storage medium 1410 includes a text detection module 1427.

The computer system 1400 may also comprise software elements, which are machine readable instructions, shown as being currently located within a working memory 1418, including an operating system 1420 and/or other code 1422, such as an application program (which may be a client application, Web browser, mid-tier application, etc.). It should be appreciated that alternate embodiments of a computer system 1400 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method of text detection, the method comprising:
receiving, by a computer, an input image;
performing edge detection on the input image;
generating an edge map based on the input image;
generating a binary edge map;
determining a set of connected components in the binary edge map;
for each connected component in the set of connected components, determining a bounding area;
determining a set of regions of the input image based on the bounding area;
classifying each region in the set of regions;
normalizing the set of regions based on the classification; and
merging the normalized set of regions.

2. The method of claim 1, wherein the input image is an image of a graphical user interface.

3. The method of claim 1, further comprising: removing long horizontal line and long vertical lines from the binary edge map.

4. The method of claim 1, wherein the region is classified as one of a white-text region, a black-text region, and non-text region.

5. The method of claim 1, wherein classification of each region is based on at least one of a variance of stroke width for white pixels, a variance of stroke width for black pixels, a ratio of white pixels to black pixels in the region, and a ratio of white pixels to black pixels along a border of the region.

6. The method of claim 1, wherein normalizing comprises:
determining a classification of a region in the set of regions; and
inverting the pixels in the region based on the classification.

7. The method of claim 1, wherein normalizing comprises:
determining a region in the set of regions is classified as a black-text region; and
inverting the pixels in the region.

8. The method of claim 1, wherein each bounding area corresponds to a region of the input image.

9. The method of claim 1, further comprising: for each region in the set of regions, generating a binary image using an adaptive threshold.

10. The method of claim 1, wherein the bounding area is a bounding rectangle.

11. The method of claim 1, further comprising:
determining a region in the set of regions is classified as a non-text region; and
filtering-out the region from the set of regions.

12. The method of claim 1, wherein the binary edge map is generated using a global threshold.

13. A non-transitory computer-readable medium storing a plurality of instructions to control a data processor text detection, the plurality of instructions comprising instructions that cause the data processor to:
receive an image of a graphical user interface (GUI);
perform edge detection on the GUI image;
generate an edge map based on the GUI image;
generate a binary edge map;
determine a set of connected components in the binary edge map;
for each connected component in the set of connected components, determine a bounding area;
determine a set of regions of the input image based on the bounding area;
classify each region in the set of regions;
normalize the set of regions based on the classification; and
merge the normalized set of regions into a binary image.

14. The non-transitory computer-readable medium of claim 13, wherein the region is classified as one of a white-text region, a black-text region, and non-text region.

15. The non-transitory computer-readable medium of claim 13, wherein classification of each region is based on at least one of a variance of stroke width for white pixels, a variance of stroke width for black pixels, a ratio of white pixels to black pixels in the region, and a ratio of white pixels to black pixels along a border of the region.

16. The non-transitory computer-readable medium of claim 13, wherein the instructions that cause the data processor to normalize the set of regions comprise:
instructions that cause the data processor to determine a classification of a region in the set of regions; and
instructions that cause the data processor to invert the pixels in the region based on the classification.

17. The non-transitory computer-readable medium of claim 13, wherein the instructions that cause the data processor to normalize the set of regions comprise:
instructions that cause the data processor to determine a region in the set of regions is classified as a black-text region; and
instructions that cause the data processor to invert the pixels in the region.

18. A system for text detection, the system comprising:
a processor; and
a memory coupled to the processor;
wherein the processor is configured to:
receive an image of a graphical user interface (GUI);
determine a set of connected components in the GUI image;
for each connected component in the set of connected components, determine a bounding area;
determine a set of regions of the GUI image based on the bounding area;
classify each region in the set of regions;
determine a region in the set of regions is classified as a black-text region;
invert the pixels in the region; and
merge the normalized set of regions into a binary image.

19. The system of claim 18, wherein classification of each region is based on at least one of a variance of stroke width for white pixels, a variance of stroke width for black pixels, a ratio of white pixels to black pixels in the region, and a ratio of white pixels to black pixels along a border of the region.

20. The system of claim 18, wherein the region is classified as one of a white-text region, a black-text region, and non-text region.
